(19) United States
(12) Patent Application Publication
(10) Pub. No.: US 2026/0356325 A1
(43) Pub. Date: Nov. 12, 2026

(54) VEHICLE-BASED IDENTIFICATION AND REACTION TO UNWANTED ENTITIES

(71) Applicant: Ford Global Technologies, LLC, Dearborn, MI (US)

(72) Inventors: Keith Weston, Canton, MI (US); Brendan Diamond, Naples, FL (US); John Robert Van Wiemeersch, Novi, MI (US); Michael Alan Mcnees, Flat Rock, MI (US); Andrew Brady Brown, Royal Oak, MI (US); Stuart C. Salter, White Lake, MI (US)

(73) Assignee: Ford Global Technologies, LLC, Dearborn, MI (US)

(21) Appl. No.: 19/201,561

(22) Filed: May 7, 2025

(51) Int. Cl. B60R 25/30; B60Q 3/68; B60R 1/29; B60R 25/104; B60R 25/34; G06V 20/59

(52) U.S. Cl. CPC B60R 25/305; B60Q 3/68; B60R 1/29; B60R 25/104; B60R 25/34; G06V 20/59

(57) ABSTRACT

A vehicle having a vehicle camera, a vehicle light and a processor is disclosed. The vehicle camera may capture images inside the vehicle or in proximity to the vehicle. The vehicle light may enable illumination of an unwanted entity inside the vehicle or in proximity to the vehicle. The processor may illuminate the vehicle light to enable detection of a presence of the unwanted entity inside the vehicle or in proximity to the vehicle, and obtain inputs from the vehicle camera responsive to illuminating the vehicle light. The processor may detect the presence of the unwanted entity inside the vehicle or in proximity to the vehicle based on the inputs, and perform a predetermined action based on the detection.

### FIELD

The present disclosure relates to vehicles and more specifically to vehicle-based identification and reaction to unwanted entities inside a vehicle or in proximity to the vehicle.

### BACKGROUND

In some regions and/or in warmer climates, adverse creatures like snakes or other small animals may enter a vehicle when the doors are left open or when the doors are opened and closed. The presence of such animals may cause inconvenience to the vehicle users.

### BRIEF DESCRIPTION OF THE DRAWINGS

The detailed description is set forth with reference to the accompanying drawings.

The use of the same reference numerals may indicate similar or identical items. Various embodiments may utilize elements and/or components other than those illustrated in the drawings, and some elements and/or components may not be present in various embodiments.

Elements and/or components in the figures are not necessarily drawn to scale. Throughout this disclosure, depending on the context, singular and plural terminology may be used interchangeably.

FIG. 1 depicts a view of an example vehicle in accordance with the present disclosure.

FIG. 2 depicts a block diagram of a system to detect the presence of an unwanted entity and perform a remedial action in accordance with the present disclosure.

FIG. 3 depicts an example view of a parked vehicle and an unwanted entity located in proximity to the vehicle in accordance with the present disclosure.

FIG. 4 depicts a flow diagram of an example method to detect the presence of an unwanted entity and perform a remedial action in accordance with the present disclosure.

### DETAILED DESCRIPTION

### Overview

The present disclosure describes a system and method to detect the presence of an unwanted entity inside a vehicle or outside the vehicle (e.g., in proximity to the vehicle or in the vehicle's surrounding area). The unwanted entity may be any adverse creature or any potentially unsettling or unwelcome animal that may cause discomfort to a user (e.g., the driver or other vehicle occupants). The unwanted entity may be, for example, a scorpion, snake, rodent, bat, sidewinder, an adverse plant or a plant or tree known to have thorns/poison ivy/oak/bond fire remnants such as pallet wood known to contain nails, and/or the like.

It may be appreciated that the unwanted entity described above may fluoresce when exposed to Ultraviolet (UV) light, specifically Ultraviolet A, or a deep blue light. To detect the unwanted entity's presence inside or in proximity to the vehicle, the system may perform scans (e.g., interior scan and/or exterior scan) by using existing vehicle components (e.g., vehicle light, vehicle sensor(s)/camera, etc.). In some aspects, the system may perform an interior scan to detect the unwanted entity's presence inside the vehicle and perform an exterior scan to detect the unwanted entity's presence outside and in proximity to the vehicle.

The system may perform the interior scan continuously or at certain instances. For example, the system may perform the interior scan when a vehicle door or a vehicle window is opened and closed. In another instance, the system may continuously perform the interior scan when the vehicle window is left in an open state. Similarly, the system may perform the exterior scan when the vehicle is stopped or when the vehicle is put into park mode. In further aspects, the system may perform the interior scan and/or the exterior scan based on a request/input obtained from the user. The system may obtain the user request/input via a vehicle Human-Machine Interface (HMI) or a user device.

To perform the scan (e.g., the interior scan and/or the exterior scan), the system may first activate the vehicle light in the vehicle's interior portion and/or the vehicle's exterior portion to enable illumination of the unwanted entity (if it is present) inside the vehicle and/or in proximity to the vehicle. Responsive to activating the vehicle light, the system may obtain inputs/images from the vehicle camera. Based on the obtained inputs/images, the system may detect the unwanted entity's presence inside the vehicle or in proximity to the vehicle and perform a predetermined remedial action based on the detection.

As part of the predetermined remedial action, the system may output a notification for the user, via the HMI and/or the user device, indicating the unwanted entity's presence inside or outside the vehicle. The system may further identify and indicate an unwanted entity's location in the notification. In addition, the system may characterize and identify the unwanted entity's type and indicate the unwanted entity's type in the notification. In some aspects, the notification may be an audible notification in the form of voice, tone, chime, and/or the like.

In further aspects, the system may allow the user (driver and/or other passenger) to open the vehicle door on a double pull when the system detects the unwanted entity in proximity to the vehicle. Further, the system may selectively activate one or more vehicle lights to indicate/illuminate the unwanted entity's location. In addition, the system may use Artificial Intelligence (AI) to provide guidance to the user on how to handle the unwanted entity and move it away from the vehicle (e.g., if the unwanted entity is detected inside the vehicle). In addition, the system may provide guidance to the user if the user is affected (e.g., bitten) by the unwanted entity in some manner.

The present disclosure discloses a system that may automatically detect an unwanted entity's presence inside a vehicle or in proximity to the vehicle, by using vehicle's existing components. The system may further provide guidance to the user to effectively handle the unwanted entity (e.g., when the unwanted entity is present inside the vehicle). The system may additionally provide guidance to the user when the user and/or the vehicle occupants are affected by the unwanted entity in any manner. In addition, the system may selectively activate vehicle components to perform the scans to utilize the vehicle's resources appropriately.

These and other advantages of the present disclosure are provided in detail herein.

Illustrative Embodiments The disclosure will be described more fully hereinafter with reference to the accompanying drawings, in which example embodiments of the disclosure are shown, and not intended to be limiting.

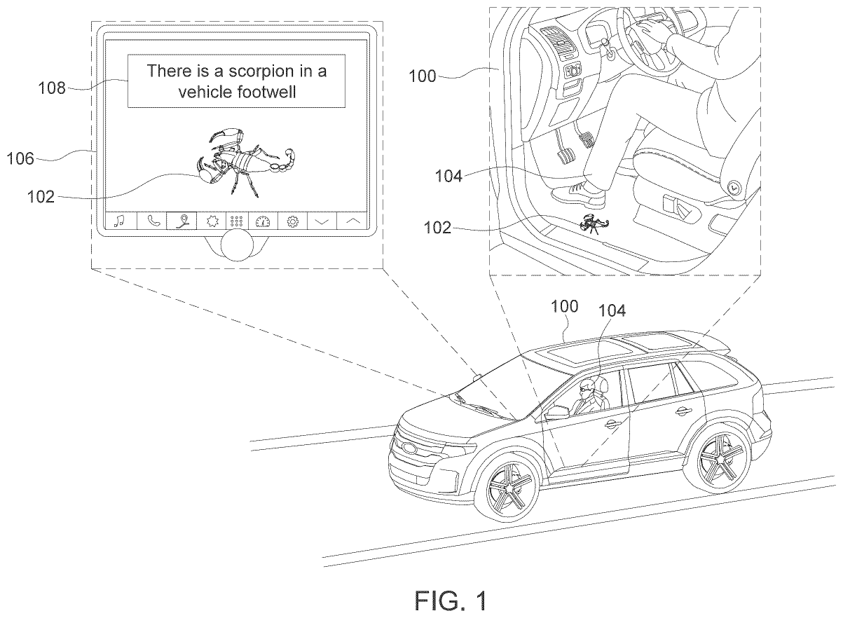

FIG. 1 depicts a view of an example vehicle 100 in accordance with the present disclosure. The vehicle 100 may take the form of any passenger or commercial vehicle such as a car, a work vehicle, a crossover vehicle, a truck, a van, a minivan, a taxi, a bus, etc. The vehicle 100 may be a manually driven vehicle or may be configured to operate in a partially/fully autonomous mode. Further, the vehicle 100 may include any powertrain, such as a gasoline engine, one or more electrically-actuated motor(s), or a hybrid system.

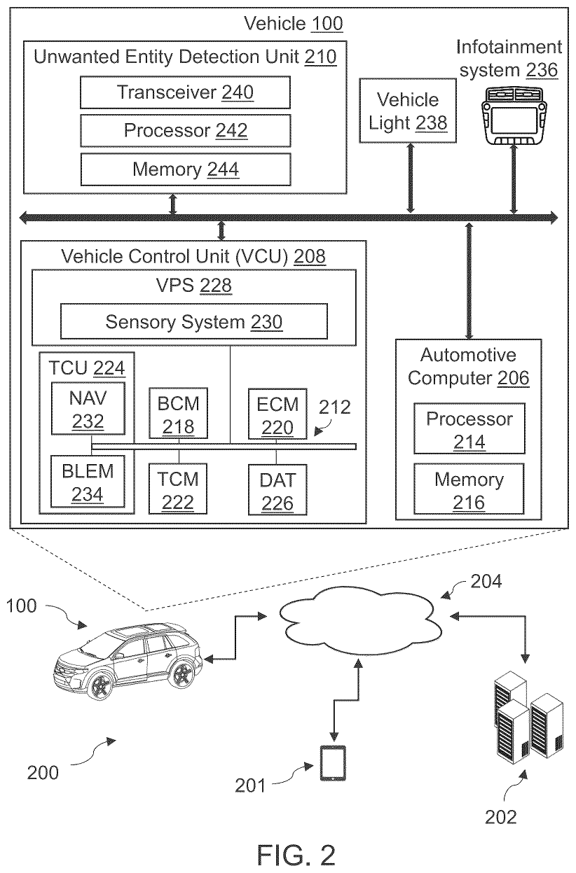

The vehicle 100 may include a plurality of vehicle components including, but not limited to, a vehicle light (shown as vehicle light 238 in FIG. 2) and one or more vehicle sensors (or a sensor suite, shown as vehicle sensory system 230 in FIG. 2). In some aspects, the vehicle sensor may be a vehicle camera, such as a vehicle interior camera and/or a vehicle exterior camera. The vehicle sensor (hereinafter referred to as vehicle camera) may capture images inside the vehicle 100 or in proximity to the vehicle 100 (e.g., images of the vehicle's surrounding area). The vehicle interior camera may capture the images of a vehicle's interior portion, and the vehicle exterior camera may capture the images of a vehicle's exterior portion or surrounding area.

The vehicle light may be located in the vehicle interior portion and/or the vehicle exterior portion and may illuminate objects/persons (including an unwanted entity 102) located inside and/or outside the vehicle 100. The unwanted entity 102 may be any adverse creature/entity or any potentially unsettling or unwelcome animal that may cause discomfort to a user 104. The unwanted entity 102 may be, for example, a scorpion, snake, rodent, bat, sidewinder, an adverse plant or a plant or tree known to have thorns/poison ivy/oak/bond fire remnants such as pallet wood known to contain nails, and/or the like.

The vehicle light may facilitate in the detection of the unwanted entity 102 inside the vehicle 100 or in proximity to the vehicle 100. In some aspects, the vehicle light may emit an Ultraviolet (UV) light. In further aspects, the vehicle light may emit a blue light. It may be appreciated that an unwanted entity (such as the unwanted entity 102 described above) may fluoresce when exposed to UV (specifically Ultraviolet A) or deep blue light. Since the vehicle light includes the UV and/or blue light, the vehicle light may enable illumination of the unwanted entity 102 inside the vehicle 100 or in proximity to the vehicle 100 (if it is present inside or outside the vehicle 100). This helps with accurate and efficient detection of the unwanted entity 102 inside the vehicle 100 or in proximity to it.

In some aspects, the vehicle light may include dual light-emitting diodes (LEDs) LEDs or blue white single LEDs. The dual LEDs may include two light-emitting diodes (LEDs) housed in a single unit, which may provide two different types of light rays. The blue white single LEDs are LEDs that appear white but are made using a blue LED core. As described above, the vehicle light may be located in the vehicle interior portion and/or the vehicle exterior portion. In the vehicle interior portion, the vehicle light may be located in the interior dome glove box, console light, courtesy lights (that typically turn on when the vehicle door is open), and/or the like. In the vehicle exterior portion, the vehicle light may be located in the door handles, headlights, license plate, back-up lamps and markers that may illuminate either blue white, RGB, UV, or both, and/or the like.

The vehicle 100 may further include an unwanted entity detection unit (shown as unwanted entity detection unit 210 in FIG. 2) that may enable unwanted entity's detection inside the vehicle 100 and/or in proximity to the vehicle 100. The unwanted entity detection unit (“unit”) may perform/activate interior scan to detect the unwanted entity 102 inside the vehicle 100 and may perform/activate exterior scan to detect the unwanted entity 102 in proximity to the vehicle 100 (or in the vehicle's surrounding area).

The unit may perform the interior scan continuously or at certain instances. For instance, the unit may perform the interior scan when a vehicle door or a vehicle window is opened or closed. In another instance, the unit may continuously perform the interior scan when the vehicle window is left in an open state. Similarly, the unit may perform the exterior scan when the vehicle 100 is stopped or when the vehicle 100 is put into park mode. In further aspects, the unit may perform the interior scan and/or the exterior scan based on a user request/input obtained from the user 104. The unit may obtain the user request/input via a vehicle Human-Machine Interface (HMI) 106 or a user device (shown as user device 201 in FIG. 2). The user device may be, for example, a mobile phone, a laptop, a computer, a tablet, a smartwatch, or any other similar device with communication capabilities.

To perform the interior scan and/or the exterior scan, the unit may control the operation of the vehicle camera and the vehicle light. In some aspects, to perform the scan, the unit may first activate the vehicle light in the vehicle interior portion and/or the vehicle exterior portion to enable unwanted entity's illumination (if it is present) inside the vehicle 100 and/or in proximity to the vehicle 100. Responsive to activating the vehicle light, the unit may obtain inputs/images from the vehicle camera. Based on the inputs obtained from the vehicle camera, the unit may detect the unwanted entity's presence inside the vehicle 100 or in proximity to the vehicle 100 and perform a predetermined remedial action based on the detection. As an example, to perform the interior scan to detect the unwanted entity 102 inside the vehicle 100, the unit may activate the vehicle light in the vehicle interior portion and may obtain the images from the vehicle's interior camera. As another example, to perform the exterior scan to detect the unwanted entity 102 in proximity to the vehicle 100, the unit may activate the vehicle light in the vehicle's exterior portion and may obtain the images from the vehicle's exterior camera.

In some aspects, the unit may execute one or more image processing algorithms on the images captured by the vehicle camera to detect the unwanted entity 102. For example, the unit may apply known filters (sharpening, Gaussian, Laplacian of Gaussian, Sobel, Prewitt, low pass filtering to reduce noise, etc.) and implement Region-Of-Interest analysis techniques to enhance the detection process of the unwanted entity 102.

In some aspects, to detect the unwanted entity 102, the unit may first determine the presence of an entity inside the vehicle 100 or in proximity to the vehicle 100 based on the inputs/images obtained from the vehicle camera. Responsive to determining the entity's presence, the unit may correlate the obtained images with an information (e.g., pre-stored images, details, etc.) associated with a plurality of unwanted entities obtained from a server (shown as server 202 shown in FIG. 2) or the user 104. Based on the correlation, the unit may determine that the entity is the unwanted entity 102. In this manner, the unit may look for and identify adverse creatures such as snakes, scorpion, etc., which may pose a threat to users, in the images obtained from the vehicle camera (e.g., by correlating the obtained images with the pre-stored images of multiple unwanted entities). In further aspects, the unit may look for and identify other creatures/entities, which may cause discomfort to the user 104 (e.g., specific plants the user 104 may be allergic to), in the image obtained from the vehicle camera. In an exemplary aspect, the unit may identify such other creatures/entities based on the user inputs obtained via the HMI 106 and/or the user device.

Responsive to detecting the unwanted entity 102, the unit may perform the predetermined remedial action. For instance, the unit may output a notification 108 for the user 104, via the HMI 106 and/or the user device, indicating the unwanted entity's presence in the vehicle 100 (or in proximity to the vehicle 100). The unit may further identify and indicate an unwanted entity's location in the notification 108. For instance, the unit may indicate in the notification 108 that the unwanted entity 102 is present in the footwell (as shown in FIG. 1) in the vehicle 100. In a similar manner, the unit may indicate that the unwanted entity 102 is present in proximity to (and outside of) the vehicle 100, such as near the front passenger's door. In addition, the unit may characterize and identify the unwanted entity's type and indicate the unwanted entity's type in the notification 108. The unit may identify the unwanted entity's type based on the correlation of the images obtained from the vehicle camera with the information associated with the plurality of unwanted entities obtained from the server. For example, the unit may indicate that “scorpion” is present in the footwell (as shown in FIG. 1) in the vehicle 100.

In some aspects, the notification may be an audible notification in the form of voice, tone, chime, and/or the like. In further aspects, the unit may allow the user 104 (driver and/or other passenger) to open the vehicle door on a double pull (may not allow via a single pull) when the unit detects that the unwanted entity 102 is located in proximity to the vehicle 100. Further, the unit may selectively activate the vehicle lights to indicate/illuminate the unwanted entity's location (e.g., via spot lighting, zone lighting, etc.).

In addition, the unit may use Artificial Intelligence (AI) to provide guidance to the user 104 to handle the unwanted entity 102. In addition, the unit may provide guidance if the user 104 (or any other vehicle passenger) is affected (e.g., bitten) by the unwanted entity 102 in some manner.

Further vehicle 100 details are described below in conjunction with FIG. 2.

The vehicle 100 implements and/or performs operations, as described here in the present disclosure, in accordance with the owner manual and safety guidelines. In addition, any action taken by the user 104 based on the notifications provided by the vehicle 100 should comply with all the rules specific to the location and operation of the vehicle 100 (e.g., Federal, state, country, city, etc.). The notifications, as provided by the vehicle 100, should be treated as suggestions and only followed according to any rules specific to the location and operation of the vehicle 100.

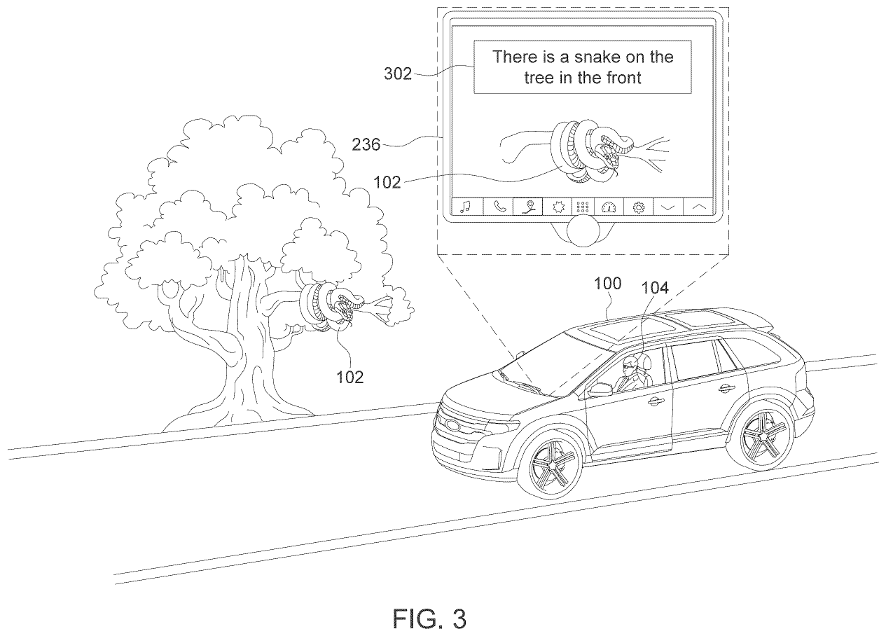

FIG. 2 depicts a block diagram of a system 200 to detect the presence of an unwanted entity and perform a remedial action in accordance with the present disclosure. While describing FIG. 2, references will be made to FIG. 3.

The system 200 may include the vehicle 100, a user device 201 and one or more servers 202 (or a server 202) that may be communicatively coupled with each other via one or more networks 204. The user device 201 may be associated with the vehicle owner/user 104 and may be, for example, a mobile phone, a laptop, a computer, a tablet, a smartwatch, or any other similar device with communication capabilities. The server 202 may be part of a cloud-based computing infrastructure and may be associated with and/or include a Telematics Service Delivery Network (SDN) that provides digital data services to the vehicle 100 and other vehicles (not shown in FIG. 2) that may be part of a vehicle fleet.

In some aspects, the server 202 may store information associated with a plurality of unwanted entities (e.g., the unwanted entity 102 described above in conjunction with FIG. 1).

For instance, the server 202 may store images and names of different unwanted entities, indications of whether the entities pose a threat to humans, characteristics associated with the entities (e.g., scorpions located in specific geographical locations are typically not poisonous), typical locations where such entities are present, why the entities are potentially adverse for humans, and/or the like. In addition, the server 202 may store information associated with guidance or best practices on how to handle the unwanted entity 102 (for example, the user may require gloves and/or a long object to guide the unwanted entity 102 to move outside the vehicle 100), steps to be taken if the user is affected (e.g., bitten) by the unwanted entity 102, and/or the like. The server 202 may transmit such information to the vehicle 100 when the server 202 receives a request from the vehicle 100 to obtain the information.

The network(s) 204 illustrates an example communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 100 may include a plurality of units including, but not limited to, an automotive computer 206, a Vehicle Control Unit (VCU) 208 and an unwanted entity detection unit 210 (or unit 210). The VCU 208 may include a plurality of Electronic Control Units (ECUs) 212 in communication with the automotive computer 206.

In some aspects, the automotive computer 206 and/or the unit 210 may be installed anywhere in the vehicle 100, in accordance with the disclosure. Further, the automotive computer 206 may operate as a functional part of the unit 210. The automotive computer 206 may be or include an electronic vehicle controller, having one or more processor(s) 214 and a memory 216. Moreover, the unit 210 may be separate from the automotive computer 206 (as shown in FIG. 2) or may be integrated as part of the automotive computer 206.

The processor(s) 214 may be in communication with one or more memory devices in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable medium or memory storing an unwanted entity detection program code. The memory 216 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 208 may share a power bus with the automotive computer 206 and may be configured and/or programmed to coordinate the data between vehicle 100 systems, connected servers (e.g., the server(s) 202), the user device 201 and other vehicles (not shown in FIG. 2) operating as part of a vehicle fleet. The VCU 208 may include or communicate with any combination of the ECUs 212, such as a Body Control Module (BCM) 218, an Engine Control Module (ECM) 220, a Transmission Control Module (TCM) 222, a Telematics Control Unit (TCU) 224, a Driver Assistances Technologies (DAT) controller 226, etc.

The VCU 208 may further include and/or communicate with a Vehicle Perception System (VPS) 228, having connectivity with and/or control of one or more vehicle sensory system(s) 230 (or a “vehicle sensor unit”). The vehicle sensory system 230 may include one or more vehicle sensors including, but not limited to, a radio detection and ranging (radar) sensor configured for detection and localization of objects inside and outside the vehicle 100 using radio waves, sitting area buckle sensors, sitting area sensors, a light detecting and ranging (lidar) sensor, door/window sensors (that may detect whether the door/window is open/closed), proximity sensors, temperature sensors, wheel sensors, ambient weather sensors, ambient light sensors, vehicle interior and exterior cameras, one or more rain sensors, a humidity sensor, a tire pressure sensor, ultrasonic sensors, one or more microphones, etc. The vehicle sensory system 230 may capture images inside the vehicle 100 and in vehicle's surroundings area (or in proximity to the vehicle 100).

In some aspects, the VCU 208 may control vehicle operational aspects and implement one or more instruction sets received from the user device 201 or from one or more instruction sets stored in the memory 216, including operational instructions as part of the unit 210.

The TCU 224 may provide vehicle connectivity to wireless computing systems onboard and off board the vehicle 100 and may include a Navigation (NAV) receiver 232 for receiving and processing a GPS signal, a BLE Module (BLEM) 234, a Wi-Fi transceiver, a UWB transceiver, and/or other wireless transceivers (not shown in FIG. 2) that may be configurable for wireless communication (including cellular communication) between the vehicle 100 and other systems (e.g., the user device 201, a key fob, an NFC device, etc.), computers, and modules. The NAV receiver 232 may be configured to determine a real-time vehicle geolocation. The TCU 224 may be in communication with the ECUs 212 by way of a bus.

The ECUs 212 may control aspects of vehicle operation and communication using inputs from human drivers, inputs from an autonomous vehicle controller, the unit 210, and/or via wireless signal inputs received via the wireless connection(s) from other connected devices, such as the user device 201, the server(s) 202, among others.

The BCM 218 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, a vehicle light 238 (same as the vehicle light described above in conjunction with FIG. 1) and/or the like. The BCM 218 may also operate as a gateway for bus and network interfaces to interact with remote ECUs (not shown in FIG. 2).

The DAT controller 226 may provide Level-1 through Level-3 automated driving and driver assistance functionality that may include, for example, active parking assistance, vehicle backup assistance, and adaptive cruise control, among other features. The DAT controller 226 may also provide aspects of user and environmental inputs usable for user authentication.

In some aspects, the automotive computer 206 may connect with an infotainment system 236 (or a vehicle Human-Machine Interface (HMI) 236). The HMI 236 may be the same as the HMI 106 described above in conjunction with FIG. 1. The HMI 236 may include a touchscreen interface portion and may include voice recognition features, biometric identification capabilities that can identify users based on facial recognition, voice recognition, fingerprint identification, or other biological identification means. In other aspects, the HMI 236 may further receive user instructions/inputs via the touchscreen interface portion and/or display notifications/recommendations, navigation maps, etc. on the touchscreen interface portion. The vehicle 100 may further include a vehicle light 238 that may be same as the vehicle light described above in conjunction with FIG. 1.

The computing system architecture of the automotive computer 206, the VCU 208, and/or the unit 210 may omit certain computing modules. It should be readily understood that the computing environment depicted in FIG. 2 is an example of a possible implementation according to the present disclosure, and thus, it should not be considered limiting or exclusive.

In accordance with some aspects, the unit 210 may be integrated with and/or executed as part of the ECUs 212. The unit 210, regardless of whether it is integrated with the automotive computer 206 or the ECUs 212, or whether it operates as an independent computing system in the vehicle 100, may include a transceiver 240, a processor 242, and a computer-readable memory 244.

The transceiver 240 may receive information/inputs from one or more external devices or systems, e.g., the user device 201, the server(s) 202, and/or the like, via the network 204. For example, the transceiver 240 may receive user inputs or request to perform the interior scan and/or the exterior scan from the user via the user device 201 (as described above in conjunction with FIG. 1). The transceiver 240 may further receive inputs/information associated with the unwanted entity 102 from the server 202. The transceiver 240 may further transmit notifications/data/signals to the external devices or systems.

In addition, the transceiver 240 may receive information/inputs from vehicle 100 components such as the HMI 236, the VCU 208 (e.g., the vehicle sensory system 230), and/or the like. For example, the transceiver 240 may receive the user inputs or request to perform the interior scan and/or the exterior scan from the user via the HMI 236. Further, the transceiver 240 may transmit notifications/command signals to the vehicle 100 components such as the VCU 208, the HMI 236, the BCM 218, the vehicle light 238, etc.

The processor 242 and the memory 244 may be the same as or similar to the processor 214 and the memory 216, respectively. In some aspects, the processor 242 may utilize the memory 244 to store programs in code and/or to store data for performing aspects in accordance with the disclosure. The memory 244 may be a non-transitory computer-readable medium or memory storing the unwanted entity detection program code.

In operation, the processor 242 may first obtain a trigger signal to detect the presence of any unwanted entity (e.g., the unwanted entity 102) inside the vehicle 100 or in proximity to the vehicle 100 (or in the vehicle's surrounding area). In some aspects, the processor 242 may obtain the trigger signal from the user 104 via the HMI 236 or the user device 201. Alternatively, or in addition, the processor 242 may obtain the trigger signal from the VCU 208 or based on inputs obtained from the VCU 208 (e.g., based on the inputs obtained from the vehicle sensory system 230), as described below.

In some aspects, the processor 242 may obtain a first trigger signal to perform an interior scan to detect the unwanted entity's presence inside the vehicle 100. The processor 242 may obtain the first trigger signal from the user 104 via the HMI 236 or the user device 201, when the user 104 desires the vehicle 100 to perform the interior scan. Alternatively or in addition, the processor 242 may obtain the first trigger signal from the VCU 208 when a vehicle door or a vehicle window moves from a closed state to an open state, or vice versa (as the probability of an unwanted entity entering the vehicle 100 is high in such scenarios). In further aspects, the processor 242 may continuously perform the interior scan when the vehicle window is left in the open state.

Similarly, the processor 242 may obtain a second trigger signal to perform an exterior scan to detect the unwanted entity's presence in proximity to the vehicle 100 or in the vehicle's surrounding area. The processor 242 may obtain the second trigger signal from the user 104 via the HMI 236 or the user device 201 when the user 104 desires the vehicle 100 to perform the exterior scan. Alternatively, or in addition, the processor 242 may obtain the second trigger signal from the VCU 208 when the vehicle 100 is stopped or when 100 the vehicle is put into park mode (as the probability associated with the user 104 exiting the vehicle 100 is high in such scenarios). The processor 242 performs the exterior scan in such scenarios to check whether any unwanted entity is present near the vehicle 100 and whether it is advisable for the user 104 to exit the vehicle 100.

Responsive to obtaining the trigger signal (e.g., the first trigger signal or the second trigger signal), the processor 242 may initiate the interior scan or the exterior scan. To perform the scan (the interior scan or the exterior scan), the processor 242 may control or activate the operation of the vehicle light 238 and the vehicle sensory system 230 (or the vehicle sensor/camera). In some aspects, to initiate the scan, the processor 242 may first activate the vehicle light 238 to enable unwanted entity's illumination (if it is present inside or outside the vehicle 100, as described above in conjunction with FIG. 1), thereby enabling the processor 242 to efficiently detect the unwanted entity's presence inside the vehicle 100 or in proximity to the vehicle 100. The processor 242 may activate the vehicle light 238 in the vehicle's interior portion responsive to obtaining the first trigger signal. Alternatively, the processor 242 may activate the vehicle light 238 in the vehicle's exterior portion responsive to obtaining the second trigger signal.

Responsive to activating the vehicle light 238, the processor 242 may activate the vehicle sensory system 230 (or the vehicle camera) to enable the vehicle sensory system 230 to capture the image of the unwanted entity 102 illuminated by the vehicle light 238. The processor 242 may obtain the inputs/images from the vehicle sensory system 230 responsive to activating the vehicle sensory system 230. While performing the interior scan, the processor 242 may activate and obtain inputs from the vehicle interior camera when the processor 242 activates the vehicle light 238 in the vehicle's interior portion. Similarly, while performing the exterior scan, the processor 242 may activate and obtain inputs from the vehicle exterior camera when the processor 242 activates the vehicle light 238 in the vehicle's exterior portion.

Responsive to obtaining the inputs/images from the vehicle camera, the processor 242 may detect the unwanted entity's presence inside the vehicle 100 or in proximity to the vehicle 100 based on the obtained inputs/images. The processor 242 may detect the unwanted entity's presence inside the vehicle 100 by using the interior scan (e.g., by using the vehicle interior camera and the vehicle light 238 located in the vehicle's interior portion). Similarly, the processor 242 may detect the unwanted entity's presence in proximity to the vehicle 100 or outside the vehicle 100 by using the exterior scan (e.g., by using the vehicle exterior camera and the vehicle light 238 located in the vehicle's exterior portion).

In addition to performing the scan as described above, the processor 242 may obtain the information associated with multiple unwanted entities from the server 202, by transmitting a request to the server 202. The server 202 may obtain the request and transmit the required inputs/information (including images of multiple unwanted entities and their respective names/types) to the processor 242, via the transceiver 240. Responsive to obtaining this information from the server 202, the processor 242 may compare/correlate the image captured by the vehicle camera with the images obtained from the server 202. The processor 242 may detect the unwanted entity's presence in the image obtained from the vehicle camera (and hence its presence inside or outside the vehicle 100) based on the comparison/correlation. For example, if the captured image substantially matches with at least one image obtained from the server, the processor 242 may determine that an unwanted entity (e.g., the unwanted entity 102) may be present inside or outside the vehicle 100.

In some aspects, the processor 242 may perform image processing on the images obtained from the vehicle camera to detect the unwanted entity's presence. Stated another way, the processor 242 may use image processing techniques to determine whether the image obtained from the vehicle camera depicts any unwanted entity (by correlating the image with the images obtained from the server 202, as described above). For example, the processor 242 may apply known filters (sharpening, Gaussian, Laplacian of Gaussian, Sobel, Prewitt, low pass filtering to reduce noise, etc.) and implement Region-Of-Interest analysis techniques to further enhance the detection process of the unwanted entity 102 in the image obtained from the vehicle camera.

As described above, to detect the unwanted entity 102, the processor 242 may first determine the presence of an entity inside the vehicle 100 or in proximity to the vehicle 100 based on the inputs/images obtained from the vehicle camera. Responsive to determining the entity's presence, the processor 242 may correlate the captured images with the information obtained from the server 202 (or the user 104). Based on the correlation, the processor 242 may determine that the entity is the unwanted entity. In this manner, the processor 242 may look for and identify adverse creatures such as snakes, scorpion, etc., which are known to pose a threat to humans, in the images obtained from the vehicle camera based on information obtained from the server 202. Stated another way, the processor 242 may identify and characterize the unwanted entity 102 based on the information or inputs obtained from the server 202. For instance, the processor 242 may determine that the unwanted entity 102 is a snake, which may pose a threat to the user 104, based on the information obtained from the server 202. In further aspects, as described above in conjunction with FIG. 1, the processor 242 may look for and identify other creatures, which may cause discomfort to the user 104, in the image obtained from the vehicle camera (e.g., based on the user inputs obtained via the HMI 106 and/or the user device 201). Stated another way, the processor 242 may identify and characterize the unwanted entity 102 based on the inputs obtained from the user 104. In some aspects, the processor 242 may use Artificial Intelligence (AI)/Machine Learning (ML) Models to characterize/identify the unwanted entity in the image obtained from the vehicle camera.

In addition, the processor 242 may determine an unwanted entity's location inside or outside the vehicle 100 based on the images obtained from the vehicle camera. For example, the processor 242 may determine that the unwanted entity 102 is present in a vehicle foot well based on the images obtained from the vehicle camera (e.g., based on the location of the vehicle camera that has captured the unwanted entity's image and/or the vehicle component captured in the image in addition to the unwanted entity 102). Similarly, the processor 242 may determine that the unwanted entity 102 is present on a tree located in a vehicle's front portion (e.g., based on the location of the vehicle camera that has captured the unwanted entity's image). For example, when the processor 242 detects the unwanted entity's presence based on the images obtained from a vehicle's front exterior camera, the processor 242 may determine that the unwanted entity 102 is present in the vehicle's front portion.

As described above, the processor 242 may perform one or more predetermined remedial actions responsive to detecting the unwanted entity's presence. In one exemplary aspect, the processor 242 may output a first notification (e.g., the notification 108 described above in conjunction with FIG. 1) on the HMI 236 or the user device 201 responsive to detecting the unwanted entity's presence, indicating to the user 104 that the unwanted entity 102 is present inside or in proximity to the vehicle 100. In addition, the processor 242 may characterize and identify the unwanted entity's type and indicate the unwanted entity's type in the first notification. The processor 242 may identify the unwanted entity's type based on correlation of the images obtained from the vehicle camera with the information associated with the plurality of unwanted entities obtained from the server 202 (or the user 104). For instance, when the processor 242 detects a scorpion inside the vehicle 100, the processor 242 may output notification that “scorpion” is present inside the vehicle 100. The notification 108 may further provide additional information associated with the unwanted entity 102. For instance, the notification 108 may indicate the unwanted entity's location, such as in the foot well, dome glove box, and/or the like.

Similarly, when the processor 242 detects that a snake is located on a tree located in the vehicle's front portion, the processor 242 may output a second notification 302 indicating that a snake is present in proximity to the vehicle 100, as depicted in FIG. 3. The notification 302 may further provide additional information associated with the unwanted entity 102. For instance, the notification 302 may include the snake's location, such as the tree located in the vehicle's front portion.

The notifications described above (e.g., the notification 108 and/or notification 302) may further include indication on how to prevent interaction with the unwanted entity 102. For instance, the notification may indicate that the snake is located in proximity to the front passenger door, so the user should not open and exit from the front passenger door. Alternatively, the notification may suggest the user 104 move to another location and then open the vehicle door.

In further aspects, as part of the predetermined remedial action, the processor 242 may use the inputs or information associated with multiple unwanted entities obtained from the server 202 and provide guidance to the user 104 on how to handle the unwanted entity 102. For example, the processor 242 may use the information associated with multiple unwanted entities obtained from the server 202 to determine that an effective way to handle a scorpion is to wear a glove and then remove it from the vehicle or push the scorpion out by using a long object/rod. The processor 242 may output such information via the notification described above, to help the user handle the situation and guide the unwanted entity 102 out of the vehicle 100.

The processor 242 may further provide (via the notification described above) information associated with potential adverse situations that the unwanted entity 102 may create for the user 104 and/or other passengers in the vehicle 100. The processor 242 may identify such information by using the inputs or information associated with multiple unwanted entities obtained from the server 202. In addition, the processor 242 may output notification to provide instructions/guidance if the user 104 (or any other vehicle passenger) is affected (e.g., bitten) by the unwanted entity 102 in any manner. The processor 242 may use AI to determine such relevant information for the user 104, by using the information/inputs obtained from the server 202.

In further aspects, as part of the predetermined remedial action, the processor 242 may output an instruction to a speaker to emit an audible notification for the user 104 to indicate the unwanted entity's presence inside the vehicle 100 or in proximity to the vehicle 100. The audible notification may be in the form of voice, tone, chime, and/or the like. In further aspects, as part of the predetermined remedial action, the processor 242 may require a double pull to allow the user 104 to open the vehicle door when the processor 242 detects that the unwanted entity 102 is located in proximity to the vehicle 100. Stated another way, the processor 242 may enable the user 104 to open the vehicle door when the processor 242 obtains a double pull signal from the user 104 when the unwanted entity 102 is located in proximity to the vehicle 100 and enable the user 104 to open the vehicle door responsive to obtaining the double pull signal.

In further aspects, as part of the predetermined remedial action, the processor 242 may determine the unwanted entity's location inside or outside the vehicle 100 based on the images obtained from the vehicle camera and selectively activate the vehicle light 238 to indicate/illuminate the determined location to enable the user 104 to identify/view the location. In further aspects, as part of the predetermined remedial action, the processor 242 may check for a presence of another user in proximity to the vehicle 100 (based on the images obtained from the vehicle cameras) when the unwanted entity 102 is located in proximity to the vehicle 100 and output an alert notification (e.g., via vehicle speakers/sound exciters) to the other user indicating the unwanted entity's presence in proximity to the vehicle 100. The notification may be in the form of voice, tone, chime, and/or the like. The processor 242 may further selectively activate the vehicle light 238 to illuminate the unwanted entity's location to further provide an indication to the other user (e.g., via spot lighting, zone lighting if the other user gets closer to the unwanted entity 102, and/or the like).

In further aspects, as part of the predetermined remedial action, the processor 242 may tag the unwanted entity's location, which may enable other vehicle users who are traveling in the same geographical location to know about the unwanted entity's location. The processor 242 may further exchange the unwanted entity's image with other vehicle users via V2V or V2X communication. For example, one user may flag a Stinging Nettle (Urtica dioica) and geofence the flagged plant's location. Other vehicles in the group may utilize their HMIs to communicate the location of the plant(s) found and utilize their camera suites to identify other examples of the same plant.

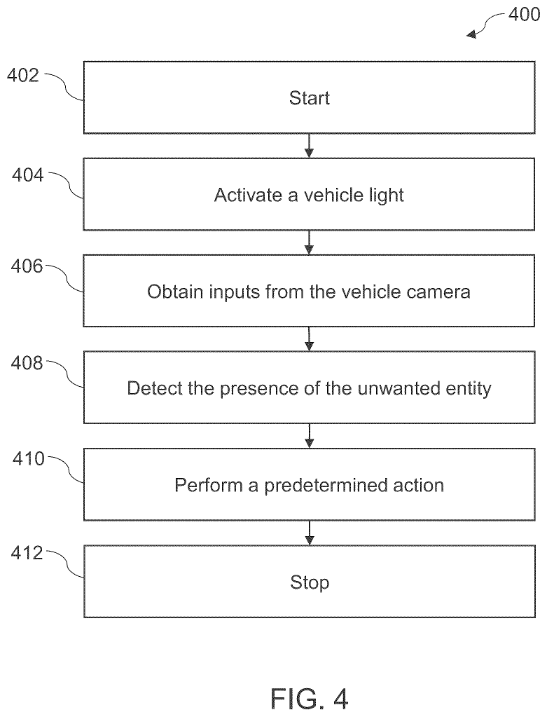

FIG. 4 depicts a flow diagram of an example method 400 to detect the unwanted entity's presence and perform a remedial action in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include activating, by the processor 242, the vehicle light 238 to enable detection of an unwanted entity's presence inside the vehicle 100 or in proximity to the vehicle 100. At step 406, the method 400 may include obtaining, by the processor 242, inputs from the vehicle camera responsive to activating the vehicle light 238. At step 408, the method 400 may include detecting, by the processor 242, the unwanted entity's presence inside the vehicle 100 or in proximity to the vehicle 100 based on the obtained inputs. At step 410, the method 400 may include performing, by the processor 242, a predetermined remedial action based on the detection.

At step 412, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle comprising:
a vehicle camera configured to capture images inside the vehicle or in proximity to the vehicle;
a vehicle light configured to emit an Ultraviolet (UV) light or a blue light to enable illumination of an targeted entity inside the vehicle or in proximity to the vehicle, wherein the targeted entity fluoresces when exposed to the UV light or the blue light; and
a processor configured to:
activate the vehicle light to expose the targeted entity to the UV light or the blue light and enable detection of a presence of the targeted entity inside the vehicle or in proximity to the vehicle;
obtain inputs from the vehicle camera responsive to activating the vehicle light;
detect the presence of the targeted entity inside the vehicle or in proximity to the vehicle based on the inputs, the inputs indicating fluorescence of the targeted entity caused by the UV light or the blue light; and
perform a predetermined action based on the detection.

2-3. (canceled)

4. The vehicle of claim 1, wherein the processor is further configured to:
obtain a first trigger signal to detect the presence of the targeted entity inside the vehicle; and
activate the vehicle light in a vehicle interior portion, responsive to obtaining the first trigger signal.

5. The vehicle of claim 4, wherein the processor obtains the first trigger signal from a vehicle control unit when a vehicle door or a vehicle window moves from a closed state to an opened state, or vice versa.

6. The vehicle of claim 4, wherein the processor obtains the first trigger signal from a vehicle Human-Machine Interface (HMI) or a user device.

7. The vehicle of claim 1, wherein the processor is further configured to:
obtain a second trigger signal to detect the presence of the targeted entity in proximity to the vehicle; and
activate the vehicle light in a vehicle exterior portion, responsive to obtaining the second trigger signal.

8. The vehicle of claim 7, wherein the processor obtains the second trigger signal from a vehicle control unit when the vehicle is stopped or when the vehicle is put into park mode.

9. The vehicle of claim 7, wherein the processor obtains the second trigger signal from a vehicle Human-Machine Interface (HMI) or a user device.

10. The vehicle of claim 1, wherein, to perform the predetermined action, the processor outputs a first notification on a vehicle Human-Machine Interface (HMI) or a user device, and wherein the first notification indicates the presence of the targeted entity inside the vehicle or in proximity to the vehicle.

11. The vehicle of claim 1, wherein, to perform the predetermined action, the processor outputs an instruction to emit an audible notification from a speaker for a vehicle user, and wherein the audible notification indicates the presence of the targeted entity inside the vehicle or in proximity to the vehicle.

12. The vehicle of claim 1, wherein, to perform the predetermined action, the processor:
obtains a double pull signal from a vehicle user to open a vehicle door when the targeted entity is located in proximity to the vehicle; and
enables the vehicle user to open the vehicle door responsive to obtaining the double pull signal.

13. The vehicle of claim 1, wherein, to perform the predetermined action, the processor:
determines a location where the targeted entity is present based on the inputs obtained from the vehicle camera; and
activates the vehicle light to indicate the location to enable a vehicle user to identify the location.

14. The vehicle of claim 1, wherein the processor is further configured to:
determine a presence of an entity inside the vehicle or in proximity to the vehicle based on the inputs obtained from the vehicle camera;
correlate the inputs with an information associated with a plurality of targeted entities obtained from a server or a vehicle user responsive to determining the presence of the entity; and
determine that the entity is the targeted entity based on the correlation.

15. The vehicle of claim 14, wherein the processor is further configured to identify a type of the targeted entity based on the correlation.

16. The vehicle of claim 1, wherein, to perform the predetermined action, the processor outputs a second notification to provide a guidance to handle the targeted entity.

17. The vehicle of claim 1, wherein, to perform the predetermined action, the processor outputs a third notification to provide a guidance to a vehicle user when the vehicle user is affected by the targeted entity.

18. The vehicle of claim 1, wherein, to perform the predetermined action, the processor:
determines a presence of a second user in proximity to the vehicle based on inputs obtained from the vehicle camera when the targeted entity is located in proximity to the vehicle; and
outputs a fourth notification for the second user, wherein the fourth notification indicates the presence of the targeted entity in proximity to the vehicle.

19. A method comprising:
activating, by a processor, a vehicle light that emits an Ultraviolet (UV) light or a blue light to enable detection of a presence of an targeted entity inside a vehicle or in proximity to the vehicle, wherein the vehicle light is configured to enable illumination of the targeted entity inside the vehicle or in proximity to the vehicle, and wherein the targeted entity fluoresces when exposed to the UV light or the blue light;
obtaining, by the processor, inputs from a vehicle camera responsive to activating the vehicle light, wherein the vehicle camera is configured to capture images inside the vehicle or in proximity to the vehicle;
detecting, by the processor, the presence of the targeted entity inside the vehicle or in proximity to the vehicle based on the inputs, the inputs indicating fluorescence of the targeted entity caused by the UV light or the blue light; and
performing, by the processor, a predetermined action based on the detection.

20. A non-transitory computer-readable storage medium having instructions stored thereupon which, when executed by a processor, cause the processor to:
activate a vehicle light that emits an Ultraviolet (UV) light or a blue light to enable detection of a presence of an targeted entity inside a vehicle or in proximity to the vehicle, wherein the vehicle light is configured to enable illumination of the targeted entity inside the vehicle or in proximity to the vehicle, and wherein the targeted entity fluoresces when exposed to the UV light or the blue light;
obtain inputs from a vehicle camera responsive to activating the vehicle light, wherein the vehicle camera is configured to capture images inside the vehicle or in proximity to the vehicle;
detect the presence of the targeted entity inside the vehicle or in proximity to the vehicle based on the inputs, the inputs indicating fluorescence of the targeted entity caused by the UV light or the blue light; and
perform a predetermined action based on the detection.

21. The vehicle of claim 1, wherein the UV light comprises Ultraviolet A (UV-A) light and the blue light comprises a deep blue light, and wherein the targeted entity fluoresces in response to exposure to the Ultraviolet A light or the deep blue light.

22. The vehicle of claim 1, wherein the targeted entity comprises an adverse creature, the adverse creature comprising at least one of a scorpion, a snake, a rodent, or a bat.
